SEQUENCE LISTING (2 sequences)

SEQ ID NO: 1 - protein, 245 aa, Artificial Sequence
  amino acid sequence of one of the preferred enzymes having phospholipase C activity
WSAEDKHNEGINSHLWIVNRAIDIMSRNTTIVNPNETALLNEWRADLENGIYSADYENPYYDDSTYASHFYDPDTGTTYIPFAKHAKETGAKYFNLAGQAYQNQDMQQAFFYLGLSLHYLGDVNQPMHAASFTDLSYPMGFHSKYENFVDTIKNNYIVSDSNGYWNWKGANPEDWIEGAAVAAKQDYPGVVNDTTKDWFVKAAVSQEYADKWRAEVTPVTGKRLMEAQRVTAGYIHLWFDTYVNR

SEQ ID NO: 2 - protein, 298 aa, Artificial Sequence
  amino acid sequence of phosphatidyl-inositol- specific phospholipase C (PI-PLC)
MASSINVLENWSRWMKPINDDIPLARISIPGTHDSGTFKLQNPIKQVWGMTQEYDFRYQMDHGARIFDIRGRLTDDNTIVLHHGPLYLYVTLHEFINEAKQFLKDNPSETIIMSLKKEYEDMKGAESSFSSTFEKNYFRDPIFLKTEGNIKLGDARGKIVLLKRYSGSNESGGYNFFYWPDNETFTSTINGNVNVTVQDKYKVSLDEKINAIKDTLNETINNSEDVNHLYINFTSLSSGGTAWTSPYYYASRINPEIANYIKQKNPTRVGWIIQDFINEKWHPLLYQEVINANKSLVK

(19) United States
(12) Patent Application Publication
(10) Pub. No.: US 2018/0168175 A1
(43) Pub. Date: Jun. 21, 2018

(54) USE OF PHOSPHOLIPASE C

(71) Applicant: DSM IP ASSETS B.V., Heerlen (NL)

(72) Inventors: Arjen SEIN, ECHT (NL); Henriëtte Maria Wilhelmina Jacoba Catharina UIJEN, ECHT (NL)

(21) Appl. No.: 15/565,944

(22) PCT Filed: Apr. 13, 2016
(86) PCT No.: PCT/EP2016/058102

§ 371 Date: Oct. 12, 2017

(30) Foreign Application Priority Data
Apr. 14, 2015 (EP) 15163485.4

(51) Int. Cl. A23C 9/12; A23C 13/16; A23C 15/12; A23C 17/02; A23C 21/02

(52) U.S. Cl. CPC A23C 9/1216; A23C 13/16; A23C 15/123; C12Y 301/04011; A23C 21/02; C12Y 301/04003; C12Y 301/01004; A23C 17/02

(57) ABSTRACT

The present invention relates to a method for producing an aqueous protein-containing milk or cream fraction, said method comprising using an enzyme having phospholipase C activity.

### FIELD OF THE INVENTION

The present invention relates to a method for producing an aqueous protein-containing milk or cream fraction, for example buttermilk, butter serum or cream serum or whey (from non-defatted whey) or powders thereof, said method comprising using an enzyme having phospholipase C activity.

### BACKGROUND OF THE INVENTION AND DETAILS OF THE INVENTION

The process to make butter and butter oil are amply described in the general literature, for instance by [Walstra, P., Geurts, T. J., Noomen, A., Jellema, A., van Boekel, M. A. J. S. (1999) Dairy Technology—Principles of Milk Properties and Processes, Marcel Dekker, New York] and [Roginski, H., Fuquay, J. W., Fox, P. F. 2003 Encyclopedia of Dairy Science, Academic press, London].

The butter process starts with (unhomogenized) cream, an oil-in-water emulsion of about 40% fat, obtained after skimming the milk. The cream can be cultured first (inoculated with lactic acid bacteria). This cream can be left to ripen, by which fat crystals can be formed. The cream is subsequently churned: high shear applied at a temperature beneficial for crystal formation, e.g. 10-15° C., or even during cooling from liquid oil stage (>40° C.) to 10-15° C. Fat crystals formed during that stage will cause the emulsion to phase invert. It is thought that crystals partly grow out of the oil droplet confinement and then by high shear the crystal can penetrate into a neighboring droplet and thereby causing a catastrophic series of droplet coalescence leading to full phase inversion. Thereby a water-in-oil emulsion is formed with some air bubbles entrained. A liquid aqueous protein-containing phase is released which is (true) buttermilk and a butter phase that is further worked on and vacuumized to remove air, and packed. See also for instance http://en.wikipedia.org/wiki/Butter.

Several butter oil processes are generally distinguished. One is starting with butter and evaporating the water, more or less leading to a product usually referred to as ghee. Industrially more often a different process is used, where cream is centrifuged another time in order to increase the fat content of the emulsion, for instance from 40 to 60% fat. The protein-containing aqueous phase that is separated here is termed butter serum, first fraction (in here referred to as BS1). Subsequently the concentrated cream is processed at elevated temperature (fat in liquid state) through a high-pressure homogenizer to break the emulsion and phase invert it into the butter oil phase and a second butter serum phase, second fraction (in here referred to as BS2). Fat and serum phases are separated by another centrifugation step at higher temperature, when the butter fat still is in the liquid state. The temperature should not be too high to ensure that no polar lipids are incorporated in the butter-oil phase. The process is aimed to minimize the polar lipid content in the oil phase. Without further measures the polar lipids—and with that also some triglycerides—will be entrained in the BS1 or BS2 phase. In the absence of polar lipids the phase inversion and the fat/serum separation will occur easier. The residual butter oil is then vacuumized to remove the last traces of water, and used as such or further fractionated in fat fractions with different melting temperatures.

Butter Milk (Powder) and Butter Serum (Powder)

The aqueous phases from both processes (butter milk, butter serum 1 and butter serum 2) are commonly high-heat pasteurized and subsequently either spray dried or left liquid to be used in all kind of other dairy products—often internally within the dairy company—or used in other food products as a cheaper ‘filler’ than normal milk streams.

The quality of these side streams is considered poorer than normal milk streams, powdered or liquid, likely caused by the presence of relatively large amounts of lipids originating from the milk fat globule membrane, see for instance [Huppertz, T., Foaming properties of milk: A review of the influence of composition and processing, Int J Dairy Techn. 2010, 63, 477-488]. Compositions vary highly by source, process and producer, examples of compositions of such products are given in the literature [Rombaut R., Dewettinck K. (2006) Properties, analysis and purification of milk polar lipids, Int. Dairy J., 16, p 1362-1373].

The properties of the aqueous protein-containing streams from butter or butter oil production are said to be poorer than other dairy sources. One aspect is that the material has higher lipid levels and the high heat treatments the material goes through before a final powder is made, leads to excessive lipid oxidation, leading to off-flavor. The other aspect will be that the lipids negatively impact foaming and gelation behaviour and renneting. The polar lipids are on the other hand believed to improve the emulsifying power of the products, leading to better stabilized oil-in-water emulsions, although the high heat load that the products receive may also lead to poorer emulsifying properties.

Aqueous protein-rich side streams from the processes of butter making and butter-oil making contain substantial levels of lipids, especially polar lipids. These side streams are known as buttermilk and butter serum. It is the aim of the present invention to provide methods for providing protein-rich aqueous phases with improved functionality, resulting from a process that separates the lipid fraction from a protein fraction. Surprisingly, this aim can be reached by using an enzyme having phospholipase C activity. Examples of the resulting protein-rich aqueous phase, are buttermilk, butter serum or cream serum which are of higher quality. Surprisingly, using an enzyme having phospholipase C activity on non-defatted whey results in a whey of higher quality.

EP1830657 describes a method for producing fractions of a milk composition treated with phospholipase, especially phospholipase A or B. This leads to the formation of lysophospholipids that improve the emulsifying properties of the resulting milk composition. Yet the presence of lysophospholipids will hamper other functional properties such as foaming, gelation and may lead to lipid oxidation. Moreover lysophospholipids taste bitter. Such will not happen after PLC treatment.

### SEQUENCE LISTING

SEQ ID NO: 1: amino acid sequence of one of the preferred enzymes having phospholipase C activity (=phospholipase C as present in the product Purifine PLC, sold by DSM).

SEQ ID NO: 2: amino acid sequence of PI-PLC (=PI-PLC as used in example 10).

### DETAILED DESCRIPTION OF THE INVENTION

In one aspect the present invention relates to a method for reducing the amount of lipids in buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

Alternatively described, the present invention relates to a method for reducing the amount of lipids in buttermilk, butter serum or cream serum, comprising treating milk or cream with an enzyme having phospholipase C activity and recovering said buttermilk, butter serum or cream serum from the enzyme treated milk or cream. The invention also relates to a method for reducing the amount of lipids in whey, comprising treating non-defatted whey with an enzyme having phospholipase C activity, optionally followed by a step to separate the neutral lipids from the whey.

In case the buttermilk, butter serum, cream serum or whey is already prepared without any added enzyme or at least without an added enzyme having phospholipase C activity, the enzyme having phospholipase activity can alternatively also be added to buttermilk, cream serum or butter serum, i.e. the invention also provides a method for treating buttermilk, butter serum, cream serum or whey with an enzyme having phospholipase C activity by adding said enzyme to said buttermilk, butter serum, cream serum or whey and by incubating at a suitable pH, temperature and time, optionally followed by a separation step, for example centrifugation, to separate the neutral lipids from the buttermilk, butter serum, cream serum or whey.

In one of its embodiments, the invention relates to a method for reducing the amount of lipids in an aqueous protein containing milk or cream fraction. The phrase “an aqueous protein-containing milk or cream fraction” refers to an aqueous protein-containing phase obtained (as a side stream or by product) in for instance a butter and/or butter oil production process. Examples of an aqueous protein-containing milk or cream fraction are buttermilk, butter serum or cream serum. However, the invention is not limited to said examples, other aqueous protein-containing milk or cream fractions can also be obtained. Yet another example of an aqueous protein-containing milk or cream fraction is whey, more preferably whey obtained from non-defatted whey.

In general, the term “buttermilk” refers to a number of dairy drinks. Originally, buttermilk was the liquid left behind after churning butter out of cream. This type of buttermilk is known as “traditional or true buttermilk”. As used herein, the term “buttermilk” preferably refers to traditional (or true) buttermilk.

Butter serum is herein used to refer to the combined aqueous protein-containing fractions of the process leading to anhydrous butter fat or butter oil. Sometimes the aqueous phase from butter is also called butter serum, obtained after separating the aqueous protein comprising phase from melted butter. Butter serum is typically high in polar lipid content.

The term “cream serum” is used for the aqueous protein-containing phase in cream and obtainable through for instance centrifugation of cream. The composition of cream serum will be close to that of butter serum and the phrases can be used interchangeably.

The term “whey” is used for the phase originating from a process whereby the casein is coagulated and separated from a liquid, protein-containing phase called whey. Coagulation can be achieved by for instance renneting of milk leading to “sweet whey” in e.g. the process for making hard cheese, or by acidification of milk leading to “acid whey”.

The term “milk” as used herein refers to milk from any mammal, for example cow, sheep, camel, buffalo or goat, preferably said milk is cow milk. The milk may be fresh milk, or heat treated (pasteurized or sterilized), but also reconstituted milk, for example milk prepared from milk powder. All these milk products contain a certain amount of lipids, even skim milk may contain up to 0.3% of lipids. Preferably, full fat milk is used in a method of the invention. To make butter or butter oil the starting point is usually cream.

The term “cream” is used herein to refer to a dairy product that is composed of the higher-butterfat layer skimmed from the top of milk before homogenization. This cream is a dispersion of fat droplets in a protein—containing water phase. In un-homogenized milk, the fat, which is less dense, will eventually rise to the top. In the industrial production of cream, this process is accelerated by using centrifuges called “separators”. In many countries, cream is sold in several grades depending on the total butterfat content. Cream can be dried to a powder for shipment to distant markets. The cream as used in a method of the invention may also be a reconstituted cream. Fat levels in cream depend on the application and typically cream will at least contain 10% lipids (w/w on wet base). Cream used to make butter or butter oil usually contains at least 30% of lipids.

Instead of directly starting from cream, one can for example also treat milk with an enzyme having phospholipase C activity, separate the cream from the enzyme treated milk and subsequently use the cream in a well-known butter or butter oil producing process which process would result in buttermilk, butter serum or cream serum with improved characteristics. The invention thus also provides a method for reducing the amount of lipids in buttermilk, butter serum or cream serum, comprising treating milk with an enzyme having phospholipase C activity and recovering cream from said enzyme treated milk and subsequently processing the obtained cream into buttermilk, butter serum or cream serum.

Preferably, the used milk in any of the herein described method has at least 1% fat and said cream comprises at least 20% fat on total (wet) product. The fat level in dairy products is commonly determined by the so-called ‘Gerber’ method known to the person skilled in the art. More preferably, the milk used in any of the claimed methods is unhomogenized milk and comprises 2 to 6%, or 3 to 4%, fat and the cream used in any of the claimed methods is unhomogenized cream and comprises at least 20 to 35% fat. Commercially sold milk and cream is typically adjusted in respect of fat levels to make sure that a product with comparable fat levels is sold throughout time. Preferably, the milk or cream as used in any of the claimed methods is not adjusted in respect of its fat level and is full fat milk obtained from a mammal or cream as directly obtained from such milk. Alternatively phrased, the milk as used in a method of the invention is unhomogenized milk (i.e. raw milk). Preferably, the cream as used in a method of the invention is obtained from such raw milk. Said milk or cream may be pasteurized.

The term “non-defatted whey” is used herein to refer to whey which is a by-product of a cheese producing process. Non-defatted whey typically comprises 5% of fat on dry matter, or 0.3% on wet directly from the cheese making (page 515 in “P. F. Fox et al. Fundamentals of cheese science, Aspen publishers, Gaithersburg Md. USA).

As described, the invention provides a method for reducing the amount of lipids in buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

I.e. the herein referred to buttermilk, butter serum or cream serum is derived from milk or cream. The herein referred to whey is derived from non-defatted whey. The invention thus provides a method for reducing the amount of lipids in buttermilk, butter serum or cream serum, comprising treating milk or cream with an enzyme having phospholipase C activity and recovering said buttermilk, butter serum or cream serum from the enzyme treated milk or cream. The invention also provides a method for reducing the amount of lipids in non-defatted whey comprising treating non-defatted whey with an enzyme having phospholipase C activity.

The term “lipid” in the above described methods for reducing the amount of lipids in an aqueous protein-containing milk or cream fraction, refers to polar lipids and/or non-polar lipids. A definition of a lipid is given in among others http://en.wikipedia.org/wiki/Lipid.

Milk lipids are chiefly triacylglycerols (TAG, 95 to 98%, also called triglycerides) along with diacylglycerols (DAG, 1.3 to 1.6%), monoacylglycerols (MAG, trace), free fatty acids (0.1 to 0.4%), phospholipids (0.8 to 1.0%), sterols (0.2 to 0.4%), and other minor components, values given are for bovine milk lipids, taken from [Gunstone, F. D., Harwood, J. L., Dijkstra, A. J., Eds. (2007) The lipid handbook 3rd ed., CRC press Boca Raton]. Another report mentions 98.3 wt % TAG, 0.3 wt % DAG, 0.8% phospholipids, 0.1% cerebrosides, 0.01% gangliosides and 0.3% sterols and sterol esters [Walstra, P., Geurts, T. J., Noomen, A., Jellema, A., van Boekel, M. A. J. S. (1999) Dairy Technology—Principles of Milk Properties and Processes, Marcel Dekker, New York].

In raw milk the triglycerides are dispersed in droplets called globules. These globules are covered with a layer consisting of polar lipids and specific proteins, generally known as the milk fat globule membrane (MFGM). Molecular composition of this outer layer is extensively reported in the literature. In a review of Rombout and Dewettinck [Rombaut, R., Dewettinck, K. (2006) Properties, analysis and purification of milk polar lipids, Int. Dairy J., 16, p 1362-1373] a schematic overview is given, together with a schematic drawing of the MFGM. The membrane consists of specific proteins and polar lipids, which are both believed to have special nutritional properties [Rombaut, R., Dewettinck, K. (2006) Properties, analysis and purification of milk polar lipids, Int. Dairy J., 16, p 1362-1373], [Singh, H. (2006) The milk fat globule membrane—A biophysical system for food applications, Current Opinion Coll. Interf. Sci. 11 p 154-163], [Fong, B. Y., Norris, C. S., MacGibbon, A. K. H. (2007) Protein and lipid composition of bovine milk-fat-globule membrane, Int. Dairy J., 17 p 275-288]. Some of the proteins are also enzymes, such as an alkaline phosphatase and xanthine oxidase [p 8 in Walstra, P., Geurts, T. J., Noomen, A., Jellema, A., van Boekel, M. A. J. S. (1999) Dairy Technology—Principles of Milk Properties and Processes, Marcel Dekker, New York]. Table 1 lists all the polar lipids as reported in literature by e.g. 31P NMR [MacKenzie, A., Vyssotski, M., Nekrasov, E. (2009) Quantitative Analysis of Dairy Phospholipids by ³¹P NMR, J. Am. Oil Chem. Soc. 86 p 757-763], for detailed structures see the Lipidomics Gateway at http://www.lipidmaps.org. The major polar lipids are phosphatidyl choline (PC, 35%), phosphatidyl ethanolamine (PE, 30%) and sphingomyelin (SM, 25%), all highly responsive to hydrolysis by an enzyme having phospholipase C activity.

TABLE 1
Phospholipid profiles in the MFGM or cream reported by several authors

| | | MacKenzie 2009 | Dewettinck 2008 | Fong et al. |
|---|---|---|---|---|
| | | (mol %) | (wt %) | 2007 (wt %) |
| Phosphatidylcholine | PC | 26.5 | 35 | 31 |
| Phosphatidylinositol | PI | 7.5 | 5 | 7.1 |
| Phosphatidylserine | PS | 11.7 | 3 | 5 |
| Lysophosphatidylcholine | LPC | 1.1 | | Tr |
| Phosphatidylethanolamine | PE | 26.7 | 30 | 30.5 |
| Sphingomyelin | SM | 20.8 | 25 | 19.9 |
| Dihydrosphingomyelin | DHSM | 3.9 | | |
| Lysophosphatidylethanolamine | LPE | 1.8 | | Tr |
| Glucosylceramide | GluCer | | Tr | 0.3 |
| Lactosylceramide | LacCer | | Tr | 3.4 |
| Gangliosides | Gang | | Tr | |

The accessibility of the polar lipids for enzymes will be relatively high when the milk is still in the unhomogenized state with the milk fat globule still in its native form. After high pressure homogenization—such as commonly done for instance for milk and yoghurt—the milk fat globules will be covered by a thick protein coat, making the globules stable to coalescence and creaming. The hydrolysis of phospholipids and sphingolipids by PLC will likely be more difficult after homogenization due to expected poorer enzyme-substrate contact. It is expected that the reaction is more effective in unhomogenized milk or cream. The invention thus provides a method for reducing the amount of lipids in buttermilk, butter serum, cream serum or whey, comprising treating milk or cream with an enzyme having phospholipase C activity and recovering said buttermilk, butter serum or cream serum from the enzyme treated milk or cream, or treating non-defatted whey with an enzyme having phospholipase C activity, wherein said milk or cream is unhomogenized.

Sphingomyelins or sphingo(phospho)lipids are polar lipids occurring in animals and microorganisms. They are built up of ceramide group with a large hydrophobic moiety and a polar phosphate group, usually a choline phosphate (also called phosphocholine). There are several classes of sphingomyelinases [(EC 3.1.4.12] that hydrolyze sphingolipids into a phosphate ester and the hydrophobic moiety [Goni, F. M., Montes, L. R., Alonso, A. (2012) Phospholipases C and sphingomyelinases: Lipids as substrates and modulators of enzyme activity, Progr. Lip. Res. 51, p 238-266]. Some enzymes having phospholipase C activity can also hydrolyze sphingomyelins as is shown in the experimental part herein.

The invention thus provides a method for reducing the amount of lipids in buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity, wherein said enzyme having phospholipase C activity also has sphingomyelin activity. Preferably, the enzyme used has phospholipase C as well as activity towards sphingomyelin. More preferably, the enzyme used has activity towards sphingomyelin and dihydrosphingomyelin.

The invention further provides a method for reducing the amount of lipids in buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity., wherein said lipids are polar lipids and/or non-polar lipids such as triglycerides.

By reducing the amount of lipids in an aqueous protein-containing milk or cream fraction (such as buttermilk, butter serum or cream serum), the aqueous protein-containing fractions of the process leading to anhydrous butter fat or butter oil will be improved when compared to non-enzymatically treated fractions or when compared to phospholipase A1, A2, B or D treated fractions. Surprisingly, an enzyme having phospholipase C activity improves features of aqueous protein-containing fractions such as buttermilk, butter serum or cream serum. This is also true for whey obtained from non-defatted whey which is treated with an enzyme having phospholipase C activity. Examples of features that are improved in the resulting buttermilk, butter serum, cream serum or whey, are:
the foaming and/or gelling behavior. The lipids negatively interfere in foaming, by making instable air/water interfaces with lipids partly displacing proteins on the interface. And the lipids also negatively interfere with gelation by covering potential protein-protein interaction sites crucial for gelation to occur and to create a self-supporting gel network. As a consequence a weaker gel network is made. Gelation of dairy protein phases may take place by heat treatment, (controlled) acidification by for instance lactic acid bacteria or by enzymatic means such as chymosin.
the sensorial properties of buttermilk, butter serum or whey. The lipids easily become rancid due to lipid oxidation, especially since the streams are high temperature pasteurized and spray dried, which results in a high chance for lipid oxidation, and likely also because polar lipids are finely distributed by association with proteins, or as membrane fragments or molecular associations, and not clustered in a lipid droplets that would protect the lipids from oxidation.
the surface tension (or air/water interfacial tension) of the resulting buttermilk, butter serum, cream serum or whey is increased when compared to non-enzymatically treated or treated with phospholipase A1, A2, B or D fractions.
a buttermilk, butter serum, cream serum or whey is obtained from which rare dairy proteins (some with enzyme activity) can be more easily separated. In non-treated fractions these rare proteins are difficult to isolate because these proteins are still associated with the lipid membrane fragments. These proteins are among others adipophilin; butyrophilin; mucin 1; xanthin oxidase/dehydrogenase as is also described by [Rombaut R., Dewettinck K. (2006) Microfiltration of Butter Serum Upon Casein Micelle Destabilization, Journal of Dairy Science Vol. 89 No. 6 p 1915-1925].
   The invention thus provides, in alternative aspects:

A method for improving the foaming and/or gelling of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.
   Aspects of foaming which can be improved are foam volume (which is preferably increased) or foam stability (which is preferably increased) and foam drainage (which is preferably reduced). For gels it is expected that firmer gels are formed, with better mechanical properties. Preferably, the foaming and/or gelling is improved (i.e. increased) compared to a similar obtained sample that has not been treated with an enzyme having phospholipase C activity.

A method for improving the sensorial properties of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.
   Preferably, the sensorial properties are improved (i.e. increased) compared to a similar obtained sample that has not been treated with an enzyme having phospholipase C activity.

A method for increasing the surface tension of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity. The increase taking place as compared to non-enzymatically treated or treated with phospholipase A1, A2, B or D, i.e. preferably, the surface tension is increased compared to a similarly obtained sample that has not been treated with an enzyme having phospholipase C activity

In all alternative aspects, the enzyme having phospholipase C activity can also be added to the buttermilk, cream serum or butter serum directly, i.e. the invention also provides:
A method for improving the foaming and/or gelling behaviour of buttermilk, butter serum, cream serum or whey or any other aqueous side stream rich in protein, comprising
treating buttermilk, cream serum or butter serum or any other aqueous side stream rich in protein with an enzyme having phospholipase C activity.
A method for improving the sensorial properties of buttermilk, butter serum or whey, comprising treating buttermilk, butter serum or whey with an enzyme having phospholipase C activity.
A method for increasing the surface tension of buttermilk, butter serum, cream serum or whey or any other aqueous side stream rich in protein, comprising treating buttermilk, cream serum or butter serum or any other aqueous side stream rich in protein with an enzyme having phospholipase C activity.

In all described aspects, it can be determined after treatment with an enzyme having phospholipase C activity if the amount of lipids is decreased, the foaming and/or gelling behaviour is improved, the sensory is improved, the surface tension is increased, by comparing to a non-enzyme treated milk or cream or a non-enzyme treated buttermilk or butter serum, cream serum or whey or any other aqueous side stream rich in protein, or compared to a comparable stream treated with phospholipase A1, A2, B or D.

As shown herein within the experimental part an enzyme having phospholipase C activity is also very useful to shorten butter oil producing processes. Instead of having to use two separation steps, one separation step is now sufficient. The invention thus also provides a method for producing butter oil from (unhomogenized) milk or cream comprising incubating (unhomogenized) milk or cream with an enzyme having phospholipase C activity and using one centrifugation step to separate butter oil from an aqueous protein-containing milk or cream fraction.

Without being bound by theory, it is hypothesized that as polar lipids are amphiphiles (with a polar, water-loving hydrophilic part and an apolar, water-hating hydrophobic part), these compounds act as emulsifiers and will drag along other lipids into the aqueous protein phase, particularly apolar lipids such as triacylglycerides. Moreover the polar heads can also associate with proteins. This causes the aqueous protein-rich phases to contain lipids with all the negative consequences mentioned. If the amphiphilic character of the polar lipids can be broken into a lipidic part and a water-soluble, non-lipidic part,—such as happens by the treatment with an enzyme having phospholipase C activity—the lipidic part will stay behind in the fat phase, and the polar, hydrophilic part dissolves in the water phase. Other, particularly apolar, lipids will then also not be drawn into this aqueous protein-rich phase.

It is further thought that breaking the amphiphilic character can only be done with an enzyme having phospholipase C activity, breaking the phospholipids into a non-polar, hydrophobic moiety and a non-lipidic phosphate compound soluble in water. The enzyme preferably also breaks the sphingomyelins (making up for about 25% of all polar lipids in milk) into a non-polar ceramide and a non-lipidic phosphate compound soluble in water.

With a phospholipase A (A1 or A2), the polarity of the polar lipid will only be increased because with that enzyme a lysophospholipid+a fatty acid is created, the lysophospholipid is more amphiphilic than an intact phospholipid. And moreover the fatty acid will be under neutral or basic conditions in a soap form, which is also highly amphiphilic and thus displays emulsifying power. The resulting polar lipids will still be in the aqueous protein phase and are still capable of dragging in triacylglycerides. Because of the higher amphiphilic character of such lysophospholipids the interfacial tension will decrease as compared to the non-hydrolyzed state. Moreover these enzymes will not be able to hydrolyze sphingolipids, and have difficulty hydrolyzing phosphatidyl inositol.

With a phospholipase B the polar lipid will be hydrolyzed into a glycerol phosphate and two fatty acids, or soap molecules, still having emulsifying capacity. Moreover these enzymes will not be able to hydrolyze sphingolipids, and have difficulty hydrolyzing phosphatidyl inositol.

A phospholipase D will modify phospholipids like phosphatidyl choline (PC) and phosphatidyl ethanolamine (PE) into phosphatidic acid, still a highly amphiphilic phospholipid going to the aqueous protein phase and taking along a substantial amount of neutral lipids. And if such phospholipase D would have activity on sphingomyelins, the resulting compound would still be highly amphiphilic.

In other words, only an enzyme with phospholipase C activity breaks the emulsifying property of the polar lipids, other phospholipases keep the emulsifying property intact or even improve it. Despite the nomenclature a phospholipase C is therefore more a phosphatase rather than a lipase, acting on the phosphate group of the phospholipid. In the literature the group of phosphodiesterases contains also phospholipase C (see for instance: http://www.brenda-enzymes.info, search for phosphodiesterase; and http://en.wikipedia.org/wiki/Phosphodiesterase), and not the phospholipases A and B.

Phospholipase A, and B in contrast are truly lipases, interacting with the hydrophobic lipidic moiety of the phospholipid molecule and hydrolyzing the fatty acid from the glycerol ester moiety, a truly totally different mode of action.

The phrases “treating milk or cream with an enzyme having phospholipase C activity”, “treating non-defatted whey” and “treating buttermilk, cream serum or butter serum with an enzyme having phospholipase C activity” are performed such that the enzyme having phospholipase C activity can perform its activity, i.e. incubation takes place at a suitable temperature, pH and time. Incubating in the presence of an enzyme having phospholipase C activity may be performed in any suitable way. Incubating is preferably performed such that an enzyme having phospholipase C activity exhibits activity, as represented by the hydrolysis of phospholipids such as phosphatidylcholine (PC) and phosphatidylethanolamine (PE) into diacylglyceride and phosphocholine and phosphoethanolamine respectively, and hydrolysis of sphingomyelin into a ceramide and a phosphocholine. Suitable conditions can easily be determined by the skilled person.

Optionally, after the enzyme having phospholipase C activity has been allowed to act on cream, milk or non-defatted whey, the phospholipase may be inactivated, removed and/or reduced.

An enzyme which has phospholipase C activity in a method described herein, typically a phospholipase C, hydrolyses phospholipids just before the phosphate group releasing diacylglyceride (DAG) and a phosphate-containing head group. A phospholipase C as used herein may belong to enzyme classification EC 3.1.4.3, E.C. 3.1.4.11 (phosphoinositide phospholipase C, hydrolyzing specifically phosphatidyl inositol into a diglyceride and an inositol phosphate), E.C. 3.1.4.12 (sphingomyelin phosphodiesterases, hydrolyzing a sphingolipid into a hydrophobic moiety such as a ceramide and a phosphate group such as a choline phosphate), preferably a phospholipase C belongs to enzyme classification EC 3.1.4.3. Advantageously, an enzyme having phospholipase C activity in a method according to the present disclosure hydrolyses between 50 and 99%, such as between 60 and 98%, such as between 70 and 95%, such as between 80 and 90% of phospholipids present in milk, cream, non-defatted whey, buttermilk, butter serum, cream serum or whey into diglyceride (1,2-diacyl-sn-glycerol) and phosphocholine (or choline phosphate) and phosphoethanolamine (ethanolamine phosphate), and the sphingomyelins into a ceramide and phosphocholine (or choline phosphate).

The methods as described herein preferably use an enzyme preparation which mainly comprise an enzyme having phospholipase C activity. Minor contaminations of other enzymes might be present in such a preparation without negatively influencing a method as described herein. Preferably, said enzyme having phospholipase C activity is an enzyme preparation in which at least 50% of the overall enzymatic activity is phospholipase C activity. More preferably at least 60%, 70%, 80%, 90% or 95% of the overall enzymatic activity is phospholipase C activity. The ratio triacylglyceride lipase/phospholipase C activity in the preparation is less than 0.01, preferably less than 0.001 and most preferably less than 0.0005; i.e. an incubation with a triacylglyceride lipase in which by accident some phospholipase activity is present is not part of the invention.

Any suitable enzyme having phospholipase C activity may be used in a method as disclosed herein. An enzyme having phospholipase C activity, typically a phospholipase C, may be derived from any suitable organism for instance bacteria such a Bacillus sp. for instance B. licheniformis, B. megaterium, B. subtilis, B. cereus, Pseudomonas sp., Lysteria sp. or fungi, such a Penicillium sp. eg. P. emersonii, Aspergillus, eg. A. niger or A. oryzae, or from Kinochaeta sp. A phospholipase C may for instance be an enzyme having an amino acid sequence according to SEQ ID NO: 1 disclosed in WO2003/089620, or SEQ ID NO: 175 having at least a mutation at position 63, 131 and/or 134, disclosed in WO2005086900, or SEQ ID NO: 176 having at least a mutation at amino acid position E41 disclosed in WO2008036863. A commercial phospholipase C product is for instance Purifine® PLC produced by DSM Food Specialties. Purifine® PLC is highly active towards PC and slightly less so towards PE, not active on PA and PI. In addition, a PI-specific PLC is available commercially under the Purifine® range. Combination of PLC and PI-PLC will lead to further phospholipid hydrolysis.

The wording ‘derived’ in this context refers to the organism in which the enzyme is originally found, and does not refer to a host organism in which the enzyme may be produced. A phospholipase C may be produced in the original organism or synthetically produced, e.g. via peptide synthesis, or the DNA encoding a phospholipase C may be synthesized and transformed and expressed in a host cell. An enzyme having phospholipase C activity in a method as disclosed herein preferably comprises an amino acid sequence that has at least 80% identity to the amino acid sequence according to SEQ ID NO: 1 or 2, such as at least 85, 90, 91, 92, 93, 94, 95, 96, 97, 98, or at least 99% identity to the amino acid sequence according to SEQ ID NO: 1 or 2. An enzyme having phospholipase C activity in a method as disclosed herein may comprise an amino acid sequence according to SEQ ID NO: 1 and/or SEQ ID NO: 2.

Sequence identity, or sequence homology are used interchangeable herein. For the purpose of this invention, it is defined here that in order to determine the percentage of sequence homology or sequence identity of two amino acid sequences, the sequences are aligned for optimal comparison purposes. In order to optimize the alignment between the two sequences gaps may be introduced in any of the two sequences that are compared. Such alignment can be carried out over the full length of the sequences being compared. Alternatively, the alignment may be carried out over a shorter length, for example over about 20, about 50, about 100 or more amino acids. The sequence identity is the percentage of identical matches between the two sequences over the reported aligned region. The percent sequence identity between two amino acid sequences may be determined using the Needleman and Wunsch algorithm for the alignment of two sequences. (Needleman, S. B. and Wunsch, C. D. (1970) J. Mol. Biol. 48, 443-453). Amino acid sequences can be aligned by the algorithm. The Needleman-Wunsch algorithm has been implemented in the computer program NEEDLE. For the purpose of this invention the NEEDLE program from the EMBOSS package was used (version 2.8.0 or higher, EMBOSS: The European Molecular Biology Open Software Suite (2000) Rice, P. Longden, I. and Bleasby, A. Trends in Genetics 16, (6) pp 276-277, http://emboss.bioinformatics.nl/). For protein sequences EBLOSUM62 is used for the substitution matrix. The optional parameters used are a gap-open penalty of 10 and a gap extension penalty of 0.5. The skilled person will appreciate that all these different parameters will yield slightly different results but that the overall percentage identity of two sequences is not significantly altered when using different algorithms.

After alignment by the program NEEDLE as described above the percentage of sequence identity between a query sequence and a sequence of the invention is calculated as follows: Number of corresponding positions in the alignment showing an identical amino acid in both sequences divided by the total length of the alignment after subtraction of the total number of gaps in the alignment. The identity as defined herein can be obtained from NEEDLE by using the NOBRIEF option and is labeled in the output of the program as “longest-identity”.

An enzyme having phospholipase C can be produced by any suitable technique known to a skilled person in the art, such as fermentation. During fermentation a microorganism or host cell is cultivated in a suitable culture medium under conditions that allow expression of the enzyme having phospholipase C activity. Usually a phospholipase C is recovered from the culture medium.

An enzyme having phospholipase C activity may be used in a process as disclosed herein in substantially pure or pure or purified form. Substantially pure with regard to the enzyme having phospholipase C activity refers to an enzyme preparation which contains at the most 50% of other protein material. A pure form of an enzyme or purified enzyme is an enzyme that is essentially free of other protein material, which means that less than 10%, preferably less than 9%, 8%, 7%, 6% or less than 5% of the proteins in an enzyme preparation comprising an enzyme having phospholipase C activity is other protein material than the enzyme.

The enzyme having phospholipase C activity which is used in a method of the invention preferably has activity towards phosphatidyl choline, phosphatidyl ethanolamine, phosphatidyl serine and sphingomyelins (preferably towards sphingomyelin and dihydrosphingomyelin). Such enzyme may also have activity towards phosphatidic acid but this is not absolutely necessary because milk, cream or non-defatted whey do not comprise much phosphatidic acid. More preferably said enzyme also comprises phosphatidic acid phospholipase C activity and/or phosphatidyl-inositol phospholipase C activity (i.e. phosphatidic acid phospholipase C activity or phosphatidyl-inositol phospholipase C activity or phosphatidic acid phospholipase C activity and phosphatidyl-inositol phospholipase C activity). Alternatively, phosphatidyl-inositol (specific) phospholipase C activity is provided by using an additional (i.e. other or second or third) enzyme having phosphatidyl-inositol (specific) phospholipase C activity.

An example of an enzyme having PI-PLC activity is shown in SEQ ID NO: 2. A preferred combination of enzymes in a method as disclosed herein is an enzyme having phospholipase C activity which comprises an amino acid sequence that has at least 80% identity to the amino acid sequence according to SEQ ID NO: 1, such as at least 85, 90, 91, 92, 93, 94, 95, 96, 97, 98, or at least 99% identity to the amino acid sequence according to SEQ ID NO: 1 combined with an enzyme having phospholipase C activity which comprises an amino acid sequence that has at least 80% identity to the amino acid sequence according to SEQ ID NO: 2, such as at least 85, 90, 91, 92, 93, 94, 95, 96, 97, 98, or at least 99% identity to the amino acid sequence according to SEQ ID NO: 2.

In yet another preferred embodiment, the enzyme having phospholipase C activity is a so-called broad spectrum phospholipase which has activity towards phosphatidyl choline, phosphatidyl ethanolamine, phosphatidyl serine, phosphatidic acid, phosphatidyl inositol and sphingomyelins (preferably towards sphingomyelin and dihydrosphingomyelin).

The present invention also relates to buttermilk, cream serum, butter serum, whey or any other aqueous side stream rich in protein obtainable by any of the above described methods. Powders of buttermilk, cream serum, butter serum, whey or any other aqueous side stream rich in protein are also included herein.

The present invention also relates to a method for preparing a food composition, wherein said food composition is prepared by using buttermilk, cream serum or butter serum or any other aqueous side stream rich in protein, which is obtainable according to any one of the herein described methods.

These protein streams low in lipids are or can be used as part of other dairy processes or in dairy-based products such as cheese, yoghurt, ice cream, infant formulae, foaming compositions (such as for cappuccino), as well as non-dairy applications.

The invention further relates to a method to produce butter or butter oil with an increased level of diacylglyceride comprising treating cream or milk with an enzyme having phospholipase C activity and recovering said buttermilk or butter oil from the enzyme treated cream or milk. The resulting butter or butter oil has an improved yield, preferably the overall yield is increased by 1 or 2%. One can for example treat milk with an enzyme having phospholipase C activity, separate the cream from the enzyme treated milk and subsequently use the cream in a well-known butter or butter oil producing process.

The invention further provides use of an enzyme having phospholipase C activity
for reducing the amount of lipids in buttermilk, butter serum, cream serum or whey,
for improving the foaming and/or gelling behavior of buttermilk, butter serum, cream serum or whey,
for improving the sensorial properties of buttermilk, butter serum, cream serum or whey, or
for increasing the surface tension of buttermilk, butter serum, cream serum or whey.

Preferred features (for example—but not limited to—in respect of the enzyme used or in respect of the cream, milk or non-defatted whey) disclosed for one aspect of the invention are also applicable to other aspects of the invention.

The following examples illustrate the invention.

### EXAMPLES

### General

### ³¹P NMR

For ³¹P NMR samples were first freeze dried, then the neutral lipids were extracted by acetone (Emsure, Merck): 1 g powder was dispersed in 9 g acetone, and was left for 1 hour at room temperature, centrifuged for 20 to 40 minutes at 4,000 rpm until a clear supernatant. Then the acetone was decanted and the tubes left open for 2 days in a fume hood for the remaining acetone to evaporate. Subsequently the acetone-extracted powder was extracted with 3 ml CHCl₃/MeOH on 100 mg dry sample weight, after taking out the extract/solvent the residue is washed with 2 ml CHCl₃/MeOH, to yield the polar lipids and a part of the phosphocholine and phosphoethanolamine. These portions of CHCl₃/MeOH are combined and dried under a stream of nitrogen. This organic phase was dissolved in an aqueous solvent containing demineralized water with 10% deuterium oxide (D₂O, Cambridge Isotope Laboratories, DLM-4), 25 mg/ml deoxycholic acid (Sigma D2510), 5.84 mg/ml EDTA di Na (Titriplex III, Merck 108418), and 5.45 mg/ml TRIS base (Tris(hydroxymethyl) aminomethane, Merck 108387), of which the pH was adjusted to pH 9 using 4N KOH and to which 2 mg/ml TIP internal standard (tri-isopropylphosphate, Aldrich 554669) (accurately weighed) was added.

Then the powder remaining after CHCl₃/MeOH extraction was dissolved in water and proteins were precipitated by 40 μl hydrochloric acid, (4N, DSM); the supernatant was freeze dried. 50 mg of that freeze dried material was dissolved in 1 ml of the aqueous solvent.

All samples were measured in a Bruker 400 MHz AvanceIII NMR spectrometer with a Prodigy BBO probe. The temperature of the probe head was set at 300K.

The measurement for quantification was performed with semi-quantitative parameters: 128 scans, 90° pulse, D1=5 sec. Values are reported in μmol/g of dry weight of the sample.

In the aqueous phases the most dominant P-containing compound was always free phosphate. These phosphate levels are not reported in the results below.

### FAME for Lipid Levels

Total lipid levels were determined by converting all lipids into fatty acid methyl esters and analyzing the levels using a standard gas chromatography method, usually referred to as the ‘FAME’ method. For this the (extracted) sample is saponified and esterified to its methyl ester. These FAMEs are quantitatively determined by GC using a flame ionization detector (FID) and an internal standard of Heptadecanoic acid (FFA C17:0).

The gas chromatograph used was an Agilent 7890A equipped with a FID detector, a Combi PAL (CTC) autosampler and a split/splitless injector, further using the Chromeleon Data system (or equivalent).

### Protein Levels

The total protein level was analyzed by the Kjeldahl method.

### Minerals Levels by ICP

Mineral levels, in particular phosphorous, were determined by the ICP technique, inductively coupled plasma, using a Varian Vista Pro Inductively Coupled Plasma Emission Spectrometer. Samples were first mineralized.

### Dry Matter Determination

Dry matter measurements were formed in 2 grams of product (accurately weighed) dried at 105° C. until stable dry weight, using a Mettler LP16 moisture balance.

Abbreviations used

| phospholipid | Abbreviation |
|---|---|
| Phosphatidylcholine | PC |
| Lysophosphatidylcholine | LPC |
| Choline phosphate | C-P |
| Glycerophosphatidylcholine | GPC |
| Phosphatidylethanolamine | PE |
| Lysophosphatidylethanolamine | LPE |
| Ethanolamine phosphate | E-P |
| Glycerophosphatidylethanolamine | GPE |
| Phosphatidylinositol | PI |
| Lysophosphatidylinositol | LPI |
| Inositolphosphate | I-P |
| Phosphatidylserine | PS |
| Sphingomyelin | SM |
| Dihydrosphingomyelin | DHSM |
| Phosphatidic acid | PA |
| Free phosphate | PO4 |

### Example 1: Phospholipase C Induced Hydrolysis of Phospholipids in Dairy Cream

Commercial pasteurized and unhomogenized cream with 35% fat, dry matter content of 42% (Biologische Slagroom, Albert Heijn, the Netherlands), without hydrocolloid as stabilizer.

The cream was incubated with 1000 ppm phospholipase C (Purifine PLC, DSM, the Netherlands, batch SF 3011C, with a minimum activity of 26,000 U/ml) for 4 hours at 50° C. As reference a cream sample was only heat treated for 4 hours at 50° C. without enzyme. Samples were taken and freeze dried for ³¹P NMR analysis.

Table 2 shows the results of the P NMR analysis of this commercial 35% fat containing cream with or without PLC. Values are expressed in μmol/g of dry weight, and since no separation has taken place the dry matter content of both samples is the same. Free phosphate levels are not reported, it was the only compound observed in the water extract of the BS1 phase from non-PLC-treated cream.

TABLE 2
phospholipid composition of cream without or with PLC incubation in μmol/g

| | | cream No-E | cream No-E | cream PLC | cream PLC |
|---|---|---|---|---|---|
| phospholipid | Abbreviation | organic | water | organic | water |
| Phosphatidylcholine | PC | 4.05 | 0 | 0 | 0 |
| Choline phosphate | C-P | 0.21 | 0 | 5.68 | 1.58 |
| Phosphatidylethanolamine | PE | 3.23 | 0 | 0 | 0 |
| Lysophosphatidylethanolamine | LPE | 0.45 | 0 | 0.48 | 0 |
| Ethanolamine phosphate | E-P | 0.15 | 0 | 0.78 | 2.22 |
| Phosphatidylinositol | PI | 1.15 | 0 | 1.14 | 0 |
| Phosphatidylserine | PS | 1.52 | 0 | 0.66 | 0 |
| Sphingomyelin | SM | 5.12 | 0 | 3.64 | 0 |
| Dihydrosphingomyelin | DHSM | 1.06 | 0 | 0.44 | 0 |
| sum | | 16.93 | 0 | 12.81 | 3.80 |

| | | |
|---|---|---|
| sum organic + water | 16.93 | 16.61 |

Organic: CHCl₃/MeOH extract; water: aqueous extract after protein precipitation; No-E = no enzyme added

The results presented in Table 2 show that all PC and PE was hydrolyzed and that PS, SM and DHSM were partly hydrolyzed after treatment with phospholipase C. It is also clear that high recovery of all phosphate components has been obtained: 16.93 μmol/g without PLC and 16.61 μmol/g after PLC treatment. In closer look at the material balance: After PLC reaction the choline phosphate (C-P) level had increased by 7.05 μmol/g (5.68+1.58−0.21), originating from full conversion of PC and partial conversion of SM and DHSM: 6.15 μmol/g (4.05+5.12−3.64+1.06−0.44), and ethanolamine phosphate (E-P) had increased by 2.85 μmol/g (2.22+0.78−0.15) at the expense of total disappearance of 3.23 μmol/g PE.

Lysophospholipids were not converted by phospholipase C, as was expected.

### Overall Conclusion of Example 1:

PLC hydrolyzes most phospholipids in dairy cream: phosphatidyl choline and phosphatidyl ethanolamine fully and phosphatidyl serine and sphingomyelins partly.

### Example 2: Butter Oil and Butter from Phospholipase-Treated Cream

The creams incubated with and without phospholipase C, as described in example 1, were further processed to butter oil or butter using lab scale methods that best mimics the processes as occur on industrial scale.

To this end each of the incubated creams were divided into two parts. One part of the cream was used to make butter oil, the other to make butter.

For butter oil the incubated creams (with PLC and reference) were heated to 60° C. and centrifuged at 9,000 rpm for 20 minutes at 40° C. (Sorval RC6 PLUS). The fatty top layer, a concentrated emulsion) and the aqueous, protein-containing phase were separately collected.
The aqueous, protein-containing bottom phase is called butter serum phase BS1, further analysis see below.
The fatty top layer was mixed at high shear using a Silverson at 8,500 rpm for 15 minutes at 40° C. to induce phase inversion to a water-in-oil emulsion.
This dispersion was centrifuged at 4,000 rpm for 10 minutes at 40° C. to separate the remaining aqueous protein-containing phase bottom phase from the liquid fat phase on top. The aqueous protein-containing phase at the bottom was the second butter serum phase, BS2. Between the liquid fat phase and the bottom aqueous phase, a ‘cream phase’ was present that was not further used.
The butter oil and the butter serum (BS2) were collected separately.

The other part of the cream was used to make butter by over-whipping. For this the incubated cream was cooled down to <10° C. and whipped using a Hobart mixer equipped with a wire whisk. After a certain amount of time the whipped cream should phase invert to a butter phase and an aqueous protein-containing phase, taken as the butter milk phase (BM).

The samples produced in this way were analyzed on product-specific properties as summarized in Table 3.

TABLE 3
The analyses performed for the products in buttermilk and butter-serum
processing.

| Samples | Phospholipid | | | | | |
|---|---|---|---|---|---|---|
| No-Enzyme | composition | Total | | Total | Surface | Dry |
| and PLC treated | ³¹P NMR | protein | Minerals | fat | tension* | matter |
| Cream | x | x | x | x | | x |
| Butter | | | x | x | | x |
| Buttermilk | x | x | x | x | x | x |
| Butter-oil | | | x | x | | x |
| Butter serum | x | x | x | x | x | x |
| 1 and 2 | | | | | | |

*Surface tension measurements in example 5

The phospholipid compositions of the products made from cream are given in Table 4. From this Table it is clear that the aqueous protein-containing phases after PLC treatment of the cream had substantially less phospholipids present—only phosphatidyl inositol (PI) and sphingomyelin (SM), present in about equal (molar) amounts. This will highly impact on the functional properties of these phases: lower amount of lipids will mean less rancidity, better foaming and gelation and likely also a higher surface tension as there are much less surface-tension-lowering phospholipids present.

The ³¹P NMR results further lead to the following observations: In Butter Serum 1 (BS1), the total amount of phosphorous-containing compounds (by ³¹P NMR) was much higher in the product after PLC treatment, caused by the high levels of phosphate esters (C-P and E-P). This suggests that in the non-PLC treated product a large part of the phospholipids was still present in the concentrated cream phase.

These phospholipids showed up in the Butter Serum 2 (BS2) phase obtained from non-PLC treated cream, making this into a stream rich in phospholipids, as is also the case in industrial practice. The BS2 from the PLC-treated cream in contrast showed a lower overall P level, mostly accounted for by the phosphate esters. The majority of the phosphorous-containing compounds were already removed in the first separation step to BS1.

Also in the buttermilk (BM) fraction less lipids and high total phosphorous components levels in the product after PLC treatment was observed.

TABLE 4
Phospholipid composition of products made from commercial cream without or with PLC treatment,
analyzed by ³¹P NMR in μmol/g

| | BS1 No | | | | BS2 No | | | | BM No | | | |
|---|---|---|---|---|---|---|---|---|---|---|---|---|
| | Enzyme | | BS1 with PLC | | Enzyme | | BS2 with PLC | | Enzyme | | BM with PLC | |
| | Organic | Water | Organic | Water | Organic | Water | Organic | Water | Organic | Water | Organic | Water |
| PC | 3.53 | 0 | 0 | 0 | 29.99 | 0 | 0 | 0 | 5.90 | 0 | 0 | 0 |
| C-P | 0.35 | 0 | 12.99 | 8.17 | 0.66 | 0.11 | 12.22 | 10.17 | 0.38 | 0.38 | 8.91 | 5.94 |
| PE | 3.69 | 0 | 0 | 0 | 28.79 | 0 | 0.87 | 0 | 7.06 | 0 | 0.39 | 0 |
| LPE | 1.01 | 0 | 1.16 | 0 | 1.40 | 0 | 1.08 | 0 | 1.03 | 0 | 1.07 | 0 |
| E-P | 0.23 | 0 | 0.89 | 13.49 | 0.32 | 0 | 1.04 | 14.50 | 0.07 | 0 | 0.74 | 10.05 |
| PI | 0.95 | 0 | 0.82 | 0 | 6.70 | 1.29 | 7.89 | 0 | 1.70 | 0 | 1.45 | 0 |
| PS | 1.61 | 0 | 0.33 | 0 | 9.15 | 2.67 | 4.10 | 0 | 2.78 | 0 | 0.68 | 0 |
| SM | 8.72 | 1.03 | 8.59 | 1.38 | 9.52 | 1.29 | 10.15 | 1.84 | 9.98 | 1.25 | 6.55 | 1.09 |
| DHSM | 1.08 | 0.57 | 0.60 | 0.44 | 5.76 | 0.74 | 1.57 | 1.11 | 1.00 | 0.80 | 0.47 | 0.14 |
| Total | 21.16 | 1.61 | 25.38 | 23.47 | 92.28 | 6.10 | 38.93 | 27.62 | 29.92 | 2.44 | 20.26 | 17.22 |
| Organic | 22.76 | | 48.85 | | 98.38 | | 66.55 | | 32.35 | | 37.48 | |
| + | | | | | | | | | | | | |
| water | | | | | | | | | | | | |

TABLE 5
more compositional data of commercial cream and products derived
thereof without or with PLC treatment

| | | Commer- | | BS1 | | BS2 |
|---|---|---|---|---|---|---|
| | | cial | BS1 no | with | BS2 no | with |
| | | cream | enzyme | PLC | enzyme | PLC |
| dry matter | % | 43.4 | 9.6 | 6.9 | 18.0 | 15.9 |
| FAME | g/kg DM | 653 | 287 | 68 | 139 | 112 |
| Fat as | g/kg wet | 283 | 28 | 5 | 25 | 18 |
| FAME | | | | | | |
| total protein | g/kg DM | 20.1 | 32.4 | 11.8 | 79.4 | 76.8 |
| protein | g/kg wet | 9 | 3 | 1 | 14 | 12 |
| phosphorus | mg/kg | 597 | 880 | 610 | 1940 | 1590 |

Table 5 shows more compositional data of commercial cream and products derived thereof without or with PLC treatment.

The FAME data in Table 5 represent the total amount of fatty acids originally present in whatever form, fatty acid, neutral lipid (TAG, DAG, MAG) or polar lipid (phospholipid). Comparisons should only be made within a pair and only qualitative. Then it is clear that both butter serum fractions indeed had lower lipid levels after PLC incubation. The atomic phosphorous levels (by ICP) follow the same trend as the ³¹P NMR data within a pair, except within the BS1 samples. The P values are dominated by the free phosphates, not accounted for by ³¹P NMR.

Diacylglyceride is one of the reaction products of the PLC-induced hydrolysis of phospholipids. This product has ended up in the lipid phase. The lipid phase is therefore enriched by diacylglyceride (not measured).

Overall, the data in Table 5 show the expected trends of less lipids in the particular aqueous protein-containing phases.

General conclusion of this experiment: The phospholipase C mediated hydrolysis leads to a different oil phase/aqueous protein-containing phase separation behavior. The protein phases contain less lipids and are therefore expected to have different behavior in application.

### Example 3, Phospholipase C Induced Oil Phase Separation in Cream

Raw cream was prepared from centrifugation of a raw milk (obtained from a local farm, stored at 4° C. and heated to 40° C. using a flow pasteurizer (C. van't Riet, the Netherlands), using a SE05X Seital Separatia S.R.L. Italia stack disc centrifuge operating at 1400 rpm at 40° C. and a feed of 600 L/hr.

During incubation of this cream with phospholipase C (Purifine PLC, see example 1) at 50° C. for 4 hours an oil layer appeared on top. In the absence of PLC no oil layer separated during this treatment of 4 hours at 50° C.

The formation of this oily top layer during PLC treatment means that a process leading to butter oil can also be simplified, e.g. only one centrifuge treatment instead of the now common two steps of centrifugation and homogenization or other phase inversion process.

### Example 4, Raw Milk Incubations, Cheese Making and Whey Production

This example shows the impact of incubating raw, unhomogenized high-fat milk with phospholipase C and making a model cheese with this and analysis of the whey from this process.

Fresh non-pasteurized unhomogenized full fat milk from a local farm was incubated at 50° C. for 4 hours in two ways: 1 kg was incubated with 1000 ppm PLC; 1 kg was left without enzyme. Samples were taken for ³¹P NMR: 6 vials of 2 ml milk were centrifuged 10 min at 14,000 rpm to separate the fat layer and water phase. The aqueous phase (‘skim milk’) was sampled for ³¹P NMR, and stored at −20° C. until further analysis.

The remaining incubated milk was used to make a model cheese for whey preparation. Cheese was prepared using the coagulant Maxiren 600 BF 612148501 (600 IMSU/ml) and calcium chloride E509 33% batch 114116.

First the milk was brought to 30° C., coagulant was added: Maxiren 600 (dosage=52.5 IMSU/l milk=87.5 μl Maxiren/liter milk, together with 50% CaCl₂ 50% [dosage 25 ml/100 kg milk]). This was stirred for 3 minutes and left to set for 45 minutes. Then the coagulum was cut into cubes with a spoon. Whey and clotted milk were separated by moving the clotted milk cubes every minute very carefully for 15 min at 35° C. The clotted milk was sieved, separating cubes of clotted milk and whey. Both fractions were weighed. The whey samples and cubes clotted milk were centrifuged to separate clear whey for P NMR analyses. Further details are given in the following table.

TABLE 6
process parameters of cheese production with raw milk
without or with PLC incubation

| | No | | Purifine C | |
|---|---|---|---|---|
| Process step | enzyme | | (PLC) | |
| Amount of incubated milk | 576 | g | 532 | g |
| CaCl₂ solution added | 144 | μl | 133 | μl |
| Maxiren added | 50.4 | μl | 46.6 | μl |
| After 60 min drainage | | | | |
| Whey | 302 | g | 309 | g |
| clotted milk + whey (90 min) | 257 | g | 216 | g |
| Total grams | 559 | g | 525 | g |
| Loss grams | 17 | g | 7 | g |

| | | |
|---|---|---|
| Dry Matter [in %] | | |
| Full fat milk after incubation | 3.4% | 3.1% |
| Whey (60 min) | 1.9% | 1.9% |
| Whey (90 min) | 2.1% | 2.1% |

The full fat milk products after incubation and the whey after 60 minutes were collected, freeze dried and analyzed by ³¹P NMR. In the Table 7 below only the P compound composition of the whey samples after MeOH/CHCl₃ are given.

TABLE 7
P components of whey by MeOH/CHCl₃
extraction

| | In μmol/g | |
|---|---|---|
| whey | Ref | PLC treated |
| PC | 0.79 | 0.12 |
| C-P | 0.53 | 1.30 |
| PE | 0.65 | 0.11 |
| E-P | 0.01 | 0.03 |
| PI | 0.03 | 0.03 |
| PS | 0.05 | 0.11 |
| SM | 10.85 | 7.09 |
| DHSM | 0.27 | 0.00 |
| free PO4 | 2.26 | 0.93 |
| Sum | 13.19 | 8.77 |

The results in this table show that there are substantially less intact phospholipids in the whey made from PLC treated milk. It must be noted that the C-P and E-P values are underestimated as these are not fully extracted by MeOH/CHCl₃.

Overall Conclusion of this Example:

Phospholipid hydrolysis also occurs in unhomogenized milk, which when used in a cheese making process leads to less phospholipids in the whey.

### Example 5. Surface Tension Measurements

This example shows the effect on the surface tension of aqueous protein streams with different pretreatments.

Next to samples generated from a lab scale butter or butter-oil process as described in example 2, also true buttermilk was used, obtained from a local farm that produces raw butter and separates true buttermilk from that process. The composition of this buttermilk is given in Table 8. Furthermore some of the samples were treated with phospholipase A2 to show the effect of the presence of lysophospholipids. These products were incubated with 0.1% w/w Maxapal A2 (batch 613196801, DSM, Delft, the Netherlands) for 3 hours at 50° C., and measured without further treatment.

TABLE 8
Composition of raw commercial buttermilk obtained
from a local butter-producing farm

| | | | | Literature* |
|---|---|---|---|---|
| | μmol/g | mg/g | mol % | mol % |
| PC | 2.94 | 2.31 | 33.62 | 26.5 |
| PE | 3.49 | 2.59 | 39.84 | 26.7 |
| PI | 0.74 | 0.64 | 8.45 | 7.5 |
| PS | 1.24 | 0.97 | 14.14 | 11.7 |
| SM | 2.63 | 2.00 | 30.08 | 20.8 |
| DHSM | 0.37 | 0.28 | 4.17 | 3.9 |
| free PO4 | 2.65 | 0.25 | | |
| Sum | 11.40 | 9.05 | | |

*MacKenzie et al. 2009

### Surface Tension

The static surface tension was measured with the Wilhelmy plate method (using an Attension Sigma-70), values reported are an average of three measurements on one sample. In some cases two samples of the same product were tested prepared and tested separately. Statistical differences determined by two sided t-test. In two cases also samples were diluted by 10 mM KCl solution.

The values for static surface tensions are listed in Table 9,

TABLE 9
static surface tension of a selection of samples

| | | | Pair wise |
|---|---|---|---|
| | | surface | difference |
| | | tension | +/− |
| | Sample | [mN/m] | enzyme |
| 1 | Butter serum 1 (BS1) from commercial cream no | 32.0 | 11.8 |
| | enzyme | | |
| 2 | BS1 from commercial cream after PLC | 43.8 | |
| 3 | BS1 from commercial cream no enzyme duplicate | 30.0 | 14.3 |
| 4 | BS1 from commercial cream after PLC duplicate | 44.3 | |
| 5 | BS1 from commercial cream no enz. 10× diluted | 35.5 | 15.5 |
| | 1 mM KCl soln | | |
| 6 | BS1 from commercial cream after PLC 10× | 51.0 | |
| | diluted 1 mM KCl soln | | |
| 7 | Commercial Skim milk (Bio+, local supermarket) | 49.7 | |
| 8 | Commercial buttermilk no enzyme | 45.1 | −8.9 |
| 9 | Commercial buttermilk, post PLA2 treated | 36.2 | |
| 10 | Buttermilk from commercial cream no enzyme | 36.9 | |
| 11 | Buttermilk from commercial cream no enz., | 30.0 | −6.9 |
| | post PLA2 treated | | |
| 12 | Whey from non-enzymatically treated milk | 45.7 | |
| 13 | Whey from non-enzymatically treated milk, | 39.7 | −6.0 |
| | post PLA2 treated | | |
| 14 | Whey from PLC-treated milk | 47.5 | 1.8 [#12 |
| | | | vs #14] |

Samples 1-6, 10 and 11 are generated in example 2, samples 7-9 are commercial products, samples 12-14 are generated in example 4.

From the values in Table 9 it is clear that butter serum 1 dispersions obtained after PLC treatment have a higher static surface tension as compared to the butter serum 1 obtained after incubation without PLC (entries 1-6 in Table 9). In all cases the difference is statistically significant (P<0.01). The values come close to the value of skim milk that contains hardly any polar lipids.

Also the static surface tensions of whey obtained from a cheese process made with milk that was incubated without PLC and with PLC (entries 12 and 14) showed an increase in surface tension, the differences are statistically significantly different (P<0.005). This also indicates a reduction of the amount of phospholipids in whey as a consequence of pretreating the milk with PLC. The values for surface tension of whey products are close to what is reported in literature, 44.2 and 44.6 mN/m [Kitabatake, N., Doi, E., (1982) Surface tension and foaming of protein solutions J. Food Sci., 47, p 1218-1221, see Table 1], and 46.3 mN/m [González-Tello, P., Camacho, F., Guadix, E. M., Luzón G., González P.A. (2009) Density, Viscosity and Surface Tension of Whey Protein Concentrate Solutions, J. Food Proc. Eng. 32 p 235-247].

In contrast, all treatments with a phospholipase A2 led to a decrease of the static surface tension as the phospholipids were converted to lysophospholipids that further lower the surface tension. The same effect is seen for dairy protein-containing compositions treated with phospholipase A1, as is shown in literature [Lilbaek, H. M., Fatum, T. M., Ipsen, R., Soerensen, N. K. (2007) J. Agric. Food Chem. 55 p 2970-2978]. Compare for instance entries 8 and 9, 10 and 11, 12 and 13, all differences are statistically significant with P<0.001. [NB The difference between commercial buttermilk and buttermilk from commercial cream is the first is buttermilk obtained from a local farm that produces butter, the second is buttermilk made in-house from commercial cream.

The static surface tension measurements clearly show that protein solutions from dairy separation processes have values lower than pure protein solutions; the same samples obtained after phospholipase C treatment lead to values close to pure protein solutions, higher values than the same sample from a non-PLC treated process. Phospholipase A2 treatment leads to surface tensions lower than the untreated protein solution.

### Example 6. Foaming of Protein Phases

Butter serum was prepared as described in example 2 from cream (batch 30032015, Biologische slagroom AH [THT 13 Apr. 2015] after incubated at 50° C. with and without Purifine PLC batch SF3011C. After incubation the cream was centrifuged at 40° C. and the butter serum 1 phase was collected.

A refractometer value (using a ATC Digit-020 ATC refractometer, measuring the Brix value) was measured to quickly estimate the dry matter in the samples. This was compared with the refractometer value of freshly prepared egg white (from manually separated eggs). The values are given in Table 10

TABLE 10
Dry matter estimates based on
refractometer values

| sample | % |
|---|---|
| Egg white | 14.5 |
| No-Enzyme cream | 6.8-7.0 |
| PLC treated cream | 6.5-6.6 |

The refractometer value of both butter serum samples are in the same order of magnitude, therefore the protein level is expected to be comparable.

Table 11 shows characteristics of foams prepared from the butter serum samples and egg white by whipping 100 ml for the given time using a Philips handheld kitchen mixer CreaMix de Luxe B-GO-562.

| sample | Mixing time | Foam volume |
|---|---|---|
| Egg white | 2 min 30 sec | 500 ml |
| BS1 from No-Enzyme | 3 min | 98 ml liquid + 5 ml coarse |
| | | foam |
| BS1 from PLC treated | 3 min | 85 ml liquid + 45 ml fine |
| cream | | foam |

Clearly Butter Serum 1 obtained from phospholipase-C treated cream generates more foam than the same product obtained without PLC treatment of the cream. Moreover, the foam produced from PLC treated BS1 consists of fine gas cells instead of some coarse air bubbles in the case of the foam from BS1 obtained from non-PLC treated cream.

### Example 7: Phospholipase C and Phospholipase A2 Induced Hydrolysis of Phospholipids in Different Whey Samples

Aim: to show conversion of phospholipids by PLC and PLA2 in non-defatted whey and consequences for the whey properties.

Three different non-defatted whey samples internally prepared in Goudse cheese (with 0.25 wt % fat on wet weight determined by the Gerber method), Cheddar cheese (with 0.28 wt % fat on wet weight determined by the Gerber method) and Sweet whey (with 0.28 wt % fat on wet weight determined by the Gerber method) processes were frozen after preparation and thawed before incubation. The sweet whey is actually a duplicate of the Goudse cheese process since sweet whey is a collective noun for all non-acidified types of whey. Commonly these samples contain around 5% of lipids on dry matter, as determined by the Gerber method.

Incubation was performed with, Maxapal A₂ phospholipase A₂ (batchnumber: 613196801) and phospholipase C Purifine PLC (batchnumber SF3011C), next to a reference incubation without enzyme. Incubation was performed for 4 hours at 50° C. and 1000 ppm of enzyme was dosed. Samples were drawn before and after incubation and were subsequently freeze dried for ³¹P NMR analysis. In Table 12 the data is shown in mol % without SM and minor phospholipids. Unfortunately the original data (amount of organic phase soluble P components as measured with ³¹P NMR in different whey samples) are overestimated by a factor of 10-20, due to a too low level of internal standard. Yet the trend and relative composition (Table 12) are not affected by this too-low level of the internal standard. For clarity the relative levels in Table 12 exclude SM and minors.

TABLE 12
Relative amount of organic phase soluble P components as measured with ³¹P NMR, and expressed in
mol % of phospholipids and without data of sphingomyelin, and minor compounds

| Type of | Type | Phospholipid or reaction product in Mol % | | | | | | | |
|---|---|---|---|---|---|---|---|---|---|
| Whey | Incubation | PC | LPC | C-P | PI | PE | LPE | E-P | PS |
| Goudse | Reference | 26.3 | 1.2 | 19.1 | 5.3 | 30.8 | 6.0 | 2.4 | 9.3 |
| | PLC treated | 5.8 | 1.5 | 57.4 | 9.7 | 3.5 | 0.0 | 8.1 | 15.0 |
| | PLA₂ treated | 0.0 | 29.1 | 26.6 | 0.0 | 1.4 | 42.2 | 0.0 | 0.8 |
| Cheddar | Reference | 26.63 | 6.7 | 24.5 | 5.8 | 23.2 | 0.0 | 8.2 | 5.8 |
| | PLC treated | 7.1 | 1.1 | 40.4 | 13.9 | 7.0 | 14.6 | 4.2 | 13.1 |
| | PLA₂ treated | 2.0 | 23.0 | 28.8 | 0.0 | 0.2 | 36.0 | 6.9 | 4.7 |
| Sweet | Reference | 28.2 | 0.8 | 12.3 | 7.7 | 39.3 | 4.9 | 1.5 | 5.4 |
| | PLC treated | 4.8 | 0.0 | 52.5 | 14.3 | 1.9 | 4.0 | 7.6 | 16.3 |
| | PLA₂ treated | 15.1 | 19.1 | 23.1 | 1.0 | 7.9 | 27.3 | 6.5 | 0.7 |

The ³¹P NMR results show that conversion of the phospholipids by PLC in whey was comparable with that in cream: almost all PC and PE is converted by PLC although hydrolysis is not complete in whey. The reaction products of PE and PC are not quantitatively retrieved in the organic NMR solvent.

Another observation is that in the PLA2 incubated whey, next to PC and PE, also PS and PI are converted. Lysophospholipid formed upon PLA2 treatment will lead to reduced surface tension as will be shown below. Needless to say, PLA2 does not hydrolyze SM

The values of SM are higher than commonly observed in cream and milk (70-80 mol % versus 30 mol % normally). This might be a consequence of the applied cheese process.

After incubation no further lipid/protein phase separation was executed.

### Surface Tension

The static surface tension of the enzyme-treated non-defatted whey products was measured with the Wilhelmy plate method (using an Attension Sigma-70), values reported are an average of four measurements on one sample, results are given in table 13.

TABLE 13
Static surface tension [mN/m]

| | | | | | | Standard | |
|---|---|---|---|---|---|---|---|
| | | | | | Average | dev. | T test, P value |
| Cheddar whey (pH: 6.1) | | | | | | | |
| No enzyme | 44.65 | 44.49 | 44.37 | 44.26 | 44.4 | 0.17 | No enzyme versus |
| | | | | | | | PLC |
| | | | | | | | P = 0.025 |
| PLC treated | 45.1 | 44.84 | 44.72 | 44.65 | 44.8 | 0.20 | PLC versus PLA₂ |
| | | | | | | | P = 4.64 × 10⁻⁸ |
| PLA₂ treated | 39.17 | 38.84 | 38.57 | 38.51 | 38.8 | 0.30 | No enzyme versus |
| | | | | | | | PLA₂ |
| | | | | | | | P = 5.24 × 10⁻⁸ |
| Goudse whey (pH: 6.6) | | | | | | | |
| No enzyme | 43.83 | 43.55 | 43.37 | 43.25 | 43.5 | 0.25 | No enzyme versus |
| | | | | | | | PLC |
| | | | | | | | P = 0.003 |
| PLC treated | 44.56 | 44.34 | 44.18 | 44.06 | 44.3 | 0.22 | PLC versus PLA₂ |
| | | | | | | | P = 1.21 × 10⁻⁹ |
| PLA₂ treated | 35.76 | 35.59 | 35.42 | 35.35 | 35.5 | 0.18 | No enzyme versus |
| | | | | | | | PLA₂ |
| | | | | | | | P = 3.76 × 10⁻⁹ |
| Sweet whey (pH: 6.0) | | | | | | | |
| No enzyme | 42.66 | 42.21 | 41.98 | 41.89 | 42.2 | 0.34 | No enzyme versus |
| | | | | | | | PLC |
| | | | | | | | P = 0.0029 |
| PLC treated | 43.55 | 43.27 | 43.1 | 42.96 | 43.2 | 0.25 | PLC versus PLA₂ |
| | | | | | | | P = 1.20 × 10⁻⁸ |
| PLA₂ treated | 36.78 | 36.56 | 36.45 | 36.33 | 36.5 | 0.19 | No enzyme versus |
| | | | | | | | PLA₂ |
| | | | | | | | P = 1.18 × 10⁻⁷ |

A statistically significant increase of the surface tension was measured after PLC treatment due to the reduction of the amount of phospholipids by PLC. The difference between PLC treated and the reference was, although significant, fairly small. This is likely due to the substantial amounts of SM not converted.

Furthermore, a large and statistically significant decrease after treatment with PLA2 caused by the conversion of phospholipids into lysophospholipids was observed. The difference between the no enzyme versus PLC or PLA2 was significant, reflected in the outcome of the T test as P<0.05 (<10⁻⁷) for all combinations. It is expected that after thorough lipid/protein phase separation the differences would become even larger.

The foaming of the non-defatted whey samples was tested as follows: 20 ml of the whey, PLA2-, PLC-treated and without enzyme was simultaneously shaken and the foam volume was directly quantified visually. Increase in the whey as such was 2 ml foam, with PLA treatment no foaming was observed and after PLC treatment 5 ml foam was measured, see also table 14. Therefore, due to the decrease of the phospholipid levels by PLC the foaming capacity of the whey was improved compared to the reference. This cannot be related to difference in protein content because there is no separation between lipid phase and aqueous protein-rich phase executed.

TABLE 14
Measured foam volumes in whey post treated
with PLC and PLA₂

| Non-defatted Cheddar whey | Foam volume |
|---|---|
| post-treated with: | (ml) |
| Reference | 2 |
| PLA2 | 0 |
| PLC | 5 |

### Conclusion:

PLC treatment of non-defatted whey leads to conversion of PC and PE, leading to increase in the static surface tension and improved foaming properties. In contrast PLA2 treatment leads to reduction of the static surface tension and reduces the foaming property compared to the reference, by the formation of lysophospholipids.

### Example 8: Butter Making of Phospholipase C Incubated Cream

### Aim:

to prove that PLC induced hydrolysis can take place during cream ripening preceding butter making, and that the resulting buttermilk has lower phospholipid levels than a reference

Butter was made with the following procedure: Commercial pasteurized and un-homogenized cream with 33% fat, dry matter content of 42% (Biologische Slagroom, Albert Heijn, the Netherlands), without hydrocolloid as stabilizer (coded 011115) was incubated overnight for 20 hours at 13° C. One liter batches were treated with 1000 ppm phospholipase C, Purifine PLC, and cream as such—without enzyme.

After overnight incubation the creams were whipped in a Stephan cutter UMC5 electronic, using a special insert for the preparation of emulsions (“Emulgier Einsatz”), where it was whipped for 15 minutes at low shear (level 3), and then for 2 minutes at high shear (level 9). In case of the phospholipase C treated cream the whipping time at level 9 needed to be increased to 4.5 minutes instead of 2 minutes to enable phase inversion. Butter and buttermilk were separated into different fractions.

Diacylglyceride is one of the reaction products of the PLC-induced hydrolysis of phospholipids. This product has ended up in the lipid phase. The lipid phase is therefore enriched by diacylglyceride (not measured). This level also affects the crystallization properties of the fat phase.

Cream samples obtained after incubation and buttermilk samples were analyzed by ³¹P NMR. Only the organic soluble phase was measured, therefore the values of especially the reaction products C-P and E-P are undervalued. Results are shown in table 15 (unfortunately the original data—i.e. amount of organic phase soluble P components as measured with ³¹P NMR- are overestimated as the level of internal standard was a factor of 10-20 too low dosed). Yet the trend and relative composition (Table 15) are not affected by this too-low level of the internal standard.

TABLE 15
Relative amount of organic phase soluble P components as
measured with ³¹P NMR and shown in mol % of phospholipids
of the most crucial P components.

| | Cream incubated for | | | |
|---|---|---|---|---|
| P components in | 20 hours at 14° C. | | Buttermilk | |
| mol % | Ref | PLC | Ref | PLC |
| PC | 21.8 | 2.1 | 20.9 | 2.5 |
| C-P | 1.7 | 25.1 | 0.8 | 24.0 |
| PS | 9.5 | 6.2 | 9.1 | 6.0 |
| SM | 29.6 | 43.9 | 33.5 | 48.7 |
| DHSM | 4.0 | 5.8 | 1.5 | 4.0 |
| PE | 23.2 | 1.1 | 26.3 | 0.2 |
| E-P | 2.3 | 6.6 | 1.3 | 4.7 |
| PI | 5.8 | 8.4 | 5.9 | 8.5 |
| IP | 0.8 | 0.0 | 0.7 | 1.3 |
| PA | 1.4 | 0.9 | 0.0 | 0.1 |

The ³¹P NMR results show that conversion of the phospholipids after 20 hours at 14° C. when dosing 1000 ppm (0.1%) PLC is comparable to the conversion after 4 hours 50° C. (see for instance example 1). In the mol % values of the incubated creams the higher SM levels are caused by the absence of a major part of the reaction products that are not recovered in the organic NMR medium (CDCl₃/MeOH). After PLC treatment the PC and PE levels in the resulting buttermilk is substantially reduced. Further it can be seen that SM also gets enriched in the buttermilk fraction relative to the cream where it came from. This is independent of enzyme treatment.

Surface tension was analyzed for the buttermilk samples from reference and PLC treated cream, using the method described previously. Data is given in table 16 below.

TABLE 16

| | | | | | | SD surface |
|---|---|---|---|---|---|---|
| | | | | | Average | tension |
| | Surface tension (mN/m) | | | | (mN/m) | (mN/m) |
| Buttermilk reference | 42.42 | 42.31 | 42.24 | 42.19 | 42.3 | 0.10 |
| Buttermilk + PLC | 43.06 | 42.93 | 42.88 | 42.8 | 42.9 | 0.11 |

These static surface tension measurements show a small but significant (P=0.00015 which is P<0.05 as determined by T-test) increase of the surface tension as a consequence of PLC treatment of the cream where the buttermilk is made of. As there is still a substantial portion of SM in the sample, the surface tension value of the buttermilk obtained after PLC treatment is not as high as for a clean dairy protein preparation.

The protein content and dry matter content of the buttermilk samples were determined as described previously, results are shown in table 17. The protein levels and total dry matter content is comparable. The increase in surface tension can therefore not be attributed to a different protein level.

TABLE 17

| | Protein | DM |
|---|---|---|
| | (g/100 ml) | (%) |
| Buttermilk blank | 3.03 | 9.15 |
| Buttermilk + PLC | 3.09 | 9.12 |

### Conclusion:

Phospholipids in cream can be hydrolyzed during ripening by PLC. After butter preparation the resulting buttermilk contains substantially less PC and PE. Consequently the surface tension of the buttermilk is higher. This would mean a better foaming property.

### Example 9: Sensory Test of Buttermilk

### Aim:

to show sensorial difference between buttermilk obtained from a normal cream versus that obtained from a PLC incubated cream

Five cans of Biologische Slagroom from Albert Heijn were incubated with 1000 ppm Purifine PLC from batch AU055B1 for 20 hours at 13° C., next to references of same batch of cream without PLC. Next day butter and buttermilk were made from the incubated creams as described in the example 8. The fresh buttermilks of PLC treated versus reference were compared in a sensory Tetrad test using an internal DSM panel. The panelists have been screened on their capability to recognize the basic tastes and have passed an internal odor identification test.

In the Tetrad test, the panelists received four samples, two of which were produced without Phospholipase C and two of which are produced with the enzyme. The panelists had to group the samples in two pairs of similar products. From the group of 15 panelists 8 identified the correct groups which makes it an indicative difference with a p=0.09.

### Conclusion:

the test showed a difference in sensorial perception in this unheated buttermilk samples obtained from PLC treated cream versus the reference.

It is expected when the materials are severely heat treated—as commonly occurs—difference will become more pronounced, in favor of the buttermilk recovered from PLC-treated cream.

### Example 10: Induced Hydrolysis of Phospholipids by a Combination of PLC and PI-PLC in Dairy Cream, as Well as Some Other Phospholipases

### Aim:

to show the effect of PI-PLC (phosphatidyl-inositol-specific phospholipase C) next to normal PLC on the incubation of cream.

Commercial pasteurized and un-homogenized cream with 33% fat, dry matter content of 42% (Biologische Slagroom, Albert Heijn, the Netherlands) without hydrocolloid as stabilizer (Coded 011115) was incubated with 1000 ppm of the enzymes: PI-PLC from Verenium (lot PI-PLC Batch 27719 (i.e. SEQ ID NO: 2)), in combination with Phospholipase C: Purifine PLC Batch SF3011C. After incubation of 4 hours at 50° C. the cream was centrifuged using an Eppendorf Centrifuge 5810R with speed of 4000 rpm and 40° C. so that a separation could be made between a fat rich top layer and an aqueous protein-containing phase. This aqueous phase was further referred to as butter serum (the same as BS1 in the example 2).

In the cream and butter serum the phospholipid content was determined using ³¹P NMR as described previously. The values are given in the table 18A and B.

As reference a butter serum was used, obtained from a larger scale cream treatment under same conditions but no enzymes, centrifuged at 9000 rpm for 20 minutes at 40° C. (Sorval RC6plus).

TABLE 18A
Amount of organic phase soluble P components as measured
with ³¹P NMR and shown in μmol/g in cream and butter serum
after incubation with a combination of PLC and PI-PLC.

| P component | | |
|---|---|---|
| in μmol/g | Cream | Buttermilk |
| PC | 0.04 | 0.00 |
| C-P | 0.74 | 1.36 |
| PS | 0.22 | 0.10 |
| SM | 1.73 | 4.82 |
| PE | 0.11 | 0.28 |
| E-P | 0.22 | 0.15 |
| PI | 0.00 | 0.02 |
| IP | 0.00 | 0.02 |
| PA | 0.14 | 0.00 |

TABLE 18B
Relative amount of organic phase soluble P components as
measured with ³¹P NMR and shown in mol %, without taking
minor compounds into accound, compared to a reference

| | Reference | PLC + PI-PLC | Reference | PLC + PI-PLC |
|---|---|---|---|---|
| PC | 26.27 | 1.25 | 15.61 | 0.00 |
| C-P | 0.04 | 23.13 | 3.63 | 20.15 |
| PS | 9.81 | 6.88 | 8.74 | 1.48 |
| SM | 33.44 | 54.06 | 48.68 | 71.41 |
| PE | 21.59 | 3.44 | 17.80 | 4.15 |
| E-P | 0.55 | 6.88 | 0.00 | 2.22 |
| PI | 6.66 | 0.00 | 5.27 | 0.30 |
| I-P | 0.60 | 0.00 | 0.21 | 0.30 |
| PA | 1.05 | 4.38 | 0.35 | 0.00 |

The reaction product of the PI-PLC enzyme is inositol phosphate (I-P), that is poorly soluble in the chloroform/methanol medium for NMR.

The data in the table show that the combination of PLC and PI-PLC is clearly efficient in hydrolyzing an even larger part of the phospholipids in cream.

The total lipid content of the butter serum samples was determined as total amount of free fatty acids by FAME (See above), see table 19:

TABLE 19
Data from FFA and total phospholipids

| | Total sum of FFA |
|---|---|
| | in mg/kg |
| Butterserum as such | 1107 |
| Butterserum PiPLC + | 266 |
| PLC | |

### Conclusion:

The combination of PLC and PI-PLC is clearly efficient in hydrolyzing an even larger part of the phospholipids in cream. This results in a lower total lipid content (expressed as FAME).

### Example 11: Foam Stability Measurements with Whey Protein Isolate

### Aim:

to show the effect of phospholipases C and A2 in whey protein isolate (defatted whey)—reworking a particular patent example.

An experiment about foam stability as described in patent application WO 03/039264 was investigated and repeated. Instead of Lecitase 10L, Maxapal A2 phospholipase A2 (batch 813441451) was used, next to phospholipase C (Purifine PLC, batch AU059B1). Maxapal A2 is an almost identical phospholipase A2 as Lecitase 10L, with about equal activity (1 LCU (Lecitase) is comparable with 1 CPU (Maxapal A2), both are at around 10,000 activity units).

Whey protein isolate 90% from Volac (WPI) with ‘fat’ content being 0.2 wt % on dry matter (according to specification sheet, batch number dated as 06-2013) was used to make 10 wt % protein solutions. The protein solution was adjusted to pH 7 with use of 4N NaOH. From the protein solution 5 times 200 ml was poured into beakers. Purifine PLC and Maxapal A2 were added in duplicate next to a reference without enzyme to the separate beakers. The dosage of MaxapalA2 was the same as described in patent application WO 03/039264: In this patent application 40 LEU Lecitase 10L per gram WPI was used to incubate the whey protein isolate solution. As LEU units are comparable with that of Maxapal A2, here 40 CPU/g whey protein isolate was added. In practice this 800 μL of a 10 times diluted enzyme solution (about 10.000 CPU/g enzyme) was added to 200 ml 10% protein solution, or 4 μL enzyme solution (undiluted) to 1 gram whey protein. The dosage of Purifine PLC was kept at same volume as was used for Maxapal A2 (800 μL 10 times diluted enzyme solution).

After addition of the enzymes to the 10% WPI protein solutions, half of the protein solutions was immediately frozen before any incubation could take place, and the other half was incubated for 30 minutes at 50° C. and frozen afterwards, next to a reference without enzyme. The next day the frozen WPI solutions were thawed and 5% dispersions were made by diluting 1:1 with water. The dispersions were used in overrun measurements. From the 5% dispersions 75 ml was whipped for 10 minutes using a ‘Philips Creamix de Luxe HR1530’ kitchen mixer at maximum speed which (level 4). After whipping the foam was poured into a graded cylinder. The level of foam created was measured and the stability of the foam was followed in time by measuring the volume of the upcoming drainage. Results (selection) for foam volume and the volume of drained solution for this experiment are given in table 20.

TABLE 20
Foam and drainage data obtained after whipping 5% WPI dispersions for 10 minutes,
as function of time

| 5% WPI as such, no incubation or addition | | | | |
|---|---|---|---|---|
| Time (sec) | Foam (ml) | Drainage (ml) | | |
| 0 | 260 | 20 | | |
| 60 | 250 | 40 | | |
| 180 | 200 | 50 | | |
| 300 | 100 | 60 | | |
| 5% WPI with PLC immediately frozen | | | 5% WPI after incubation with PLC | |
| Time (sec) | Foam (ml) | Drainage (ml) | Foam (ml) | Drainage (ml) |
| 0 | 340 | 0 | 350 | 0 |
| 150 | — | — | 330 | 15 |
| 300/330 | 250 | 40 | 250 | 40 |
| 600/660 | 130 | 50 | 100 | 55 |
| 900 | 90 | 60 | — | — |
| 1080 | | | 10 | 65 |
| 5% WPI with PLA2 immediately frozen | | | 5% WPI after incubation with PLA2 | |
| Time (sec) | Foam (ml) | Drainage (ml) | Foam (ml) | Drainage (ml) |
| 0 | 290 | 5 | 300 | 10 |
| 300 | 290 | 50 | 300 | 45 |
| 600 | 290 | 55 | 280 | 55 |
| 1200 | — | — | 270 | 60 |
| 1800 | 280 | 60 | — | — |
| 2700 | 270 | 65 | 250 | 65 |

Table 20 shows that an untreated WPI solution itself made a fairly instable foam: the volume after for instance 300 seconds was reduced to 40% of its original value. Upon addition of enzymes the foam stability increased, even though no incubation had taken place: After 300 seconds about 70% of the volume remained after PLC addition and with PLA2 even more than 90% of the foam volume was left. Yet the most remarkable observation was that there is no significant difference between a foam made of WPI that was allowed to incubate for 30 minutes with either PLA2 or PLC, and a foam made of the same WPI solutions with enzymes without allowing for incubation.

### Conclusion:

the improved foam stability of defatted whey protein isolate induced by PLC or PLA2 is due to the effect of the enzymes as a protein to physically stabilize the WPI protein foam. This is not due to potential hydrolysis of phospholipids, as there are first of all hardly any present, and secondly the effect is the same for zero incubation time and 30 minutes at 50° C.

1. A method for reducing the amount of lipids in buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

2. A method according to claim 1 wherein said lipids are polar lipids and/or non-polar lipids.

3. A method for improving the foaming and/or gelling behaviour of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

4. A method for improving the sensorial properties of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

5. A method for increasing the surface tension of buttermilk, butter serum, cream serum or whey, comprising
treating milk or cream with an enzyme having phospholipase C activity and recovering said buttermilk, butter serum or cream serum from the enzyme treated milk or cream, or
treating non-defatted whey with an enzyme having phospholipase C activity.

6. A method for producing butter oil from unhomogenized milk or cream comprising incubating unhomogenized milk or cream with an enzyme having phospholipase C activity and using one centrifugation step to separate butter oil from an aqueous protein-containing milk or cream fraction.

7. A method according to claim 1, wherein said milk comprises at least 1% fat or wherein said cream comprises at least 20% fat.

8. A method according to claim 1, wherein said enzyme having phospholipase C activity is an enzyme preparation in which at least 50% of the overall enzymatic activity is phospholipase C activity.

9. A method according to claim 1, wherein said enzyme having phospholipase C activity has at least 90% identity to SEQ ID NO: 1.

10. A method according to claim 1, wherein said enzyme having phospholipase C activity has activity towards phosphatidyl choline, phosphatidyl ethanolamine, phosphatidyl serine, sphingomyelins and optionally towards phosphatidic acid.

11. A method according to claim 10, wherein said enzyme further comprises phosphatidyl-inositol phospholipase C activity.

12. A method according to claim 10, further comprising using an additional enzyme having phosphatidyl-inositol (specific) phospholipase C activity.

13. A method according to claim 12, wherein said enzyme having phosphatidyl-inositol (specific) phospholipase C activity has at least 80 or 90% identity to SEQ ID NO: 2.

14. Buttermilk, cream serum, butter serum, whey or powders thereof obtainable by the method according to claim 1.

15. A method for preparing a food composition, wherein said food composition is prepared using buttermilk, cream serum, butter serum, whey or powders thereof according to claim 14.

16. Method to produce butter or butter oil with an increased level of diacylglyceride comprising treating cream or milk with an enzyme having phospholipase C activity and recovering said buttermilk or butter oil from the enzyme treated cream or milk.
